(19) United States
(12) Patent Application Publication
(10) Pub. No.: US 2025/0266675 A1
(43) Pub. Date: Aug. 21, 2025

(54) POWER LOSS PROTECTION CIRCUIT, DATA STORAGE MODULE, AND SERVER

(71) Applicant: ROHM CO., LTD., Kyoto (JP)

(72) Inventors: Kiyoshi KONDO, Kyoto (JP); Kazunori ITOU, Kyoto (JP)

(21) Appl. No.: 19/051,580

(22) Filed: Feb. 12, 2025

(30) Foreign Application Priority Data
Feb. 15, 2024 (JP) 2024-021511

(51) Int. Cl. H02H 3/12; H02J 9/06; H02M 1/32; H02M 3/158

(52) U.S. Cl. CPC H02H 3/12; H02J 9/068; H02M 1/32; H02M 3/1582

(57) ABSTRACT

A power loss protection circuit includes: a first input terminal configured to receive, as an input voltage, a voltage generated by an intermediate bus converter configured to step down a DC bus voltage; a second input terminal configured to receive the DC bus voltage; a capacitor connection terminal to which an external capacitor is to be connected; an output terminal to which a load is to be connected; a first switch connected between the first input terminal and the output terminal; a charging circuit connected between the second input terminal and the capacitor connection terminal; and an internal converter configured to step down a voltage of the capacitor connection terminal and stabilize an output voltage generated at the output terminal to a target level.

### CROSS-REFERENCE TO RELATED APPLICATION

The present invention claims priority under 35 U.S.C. § 119 to Japanese Patent Application No. 2024-021511, filed on Feb. 15, 2024, the entire contents of which are incorporated herein by reference.

### TECHNICAL FIELD

The present disclosure relates to a power loss protection circuit.

### BACKGROUND

A stable supply of power supply voltage is required for electronic components. When a power supply voltage of a storage such as a solid state drive or a hard disk is momentarily interrupted, data stored in the storage may be destroyed or lost. Even after an input voltage is interrupted, the power supply voltage is required to be maintained for a period during which a load performs a required protection processing such as data evacuation. Such a function is called power interruption protection, power loss protection (PLP), power loss imminent (PLI), power failure protection (PFP), etc.

FIG. 1 is a block diagram of a system 2 equipped with a PLP function. The system 2 includes a main power supply 10, a load 20, and a backup circuit 30. The main power supply 10 receives an AC voltage V_{AC} and generates a bus voltage (input voltage) V_{BUS} of about 12 V. The bus voltage V_{BUS} is supplied to the backup circuit 30 and other circuits (not shown).

The load 20 includes a power management integrated circuit (PMIC) 22 and a plurality of electronic components 24_1 to 24_n. The PMIC 22 receives a power supply voltage V_{DD} of 12 V, steps-up or steps-down the received power supply voltage, and supplies the same to the electronic components 24_1 to 24_n.

The backup circuit 30 is installed between the main power supply 10 and the load 20. The backup circuit 30 includes a switch 32, a backup capacitor 34, and a boost converter 36.

The switch 32 is installed at a power supply line 38 connecting the main power supply 10 and the load 20. While a valid bus voltage V_{BUS} is supplied, the switch 32 is turned on and the bus voltage V_{BUS} is supplied as the power supply voltage V_{DD} to the load 20. An input terminal IN of the boost converter 36 is connected to the power supply line 38, and an output terminal OUT thereof is connected to the backup capacitor 34. The boost converter 36 boosts the bus voltage V_{BUS} while the bus voltage V_{BUS} is being supplied, and charges the backup capacitor 34. In a case where a capacitance of the backup capacitor 34 is C and a voltage generated in the backup capacitor 34 is V_{STR}, charge Q and energy E stored in the backup capacitor 34 are expressed by the following equations.

$$Q = C \cdot {V}_{STR}$$

$$E = C \cdot {V}_{STR}^{2} / 2$$

When detecting an interruption (loss) of the bus voltage V_{BUS}, the backup circuit 30 turns off the switch 32. Then, the boost converter 36 operates in a reverse direction as a step-down converter with an OUT side as an input and an IN side as an output, steps-down the capacitor voltage V_{STR} of the backup capacitor 34 to a voltage level of the power supply voltage V_{DD}, and supplies the same to the load 20.

In applications such as servers, there is a trend to change the bus voltage V_{BUS}, which is 12 V in the related art, to a higher voltage (42 V to 58 V) so as to reduce power loss in a bus system. In a case where the bus voltage V_{BUS} is increased, a current required to transmit the same amount of power will be reduced, and power consumption in a wiring (cable), which is proportional to a square of the current, will be reduced.

### BRIEF DESCRIPTION OF DRAWINGS

The accompanying drawings, which are incorporated in and constitute a part of the specification, illustrate embodiments of the present disclosure.

FIG. 1 is a block diagram of a system equipped with a PLP function.

FIG. 2 is a circuit diagram of a system including a backup circuit according to an embodiment of the present disclosure.

FIG. 3 is a circuit diagram of a backup circuit according to a first example.

FIG. 4 is a time chart illustrating an operation of the backup circuit of FIG. 3.

FIG. 5 is a circuit diagram of a backup circuit according to a second example.

FIG. 6 is a time chart illustrating an operation of the backup circuit of FIG. 5.

FIG. 7 is a circuit diagram of a backup circuit according to a third example.

FIG. 8 is a circuit diagram of a backup circuit according to a fourth example.

FIG. 9 is a circuit diagram of a backup circuit according to a fifth example.

FIG. 10 is a circuit diagram of a backup circuit according to a sixth example.

FIG. 11 is a circuit diagram of a backup circuit according to a seventh example.

FIG. 12 is a circuit diagram of a computer system.

### DETAILED DESCRIPTION

Reference will now be made in detail to various embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

### Overview of Embodiments

Overview of some exemplary embodiments of the present disclosure will be described. This overview presents, in a simplified form, some concepts of one or more embodiments, as a prologue to the detailed description which will be presented later, and for the purpose of basic understanding of the embodiments, but is not intended to limit a scope of the present disclosure. This overview is not a comprehensive overview of all possible embodiments, and it is intended to neither identify particular elements of all embodiments nor delineate scope of some or all aspects. For the sake of convenience, “an embodiment” may be used to refer to one embodiment (example or modification) or a plurality of embodiments (examples or modifications) disclosed herein.

A power loss protection circuit according to an embodiment of the present disclosure includes: a first input terminal configured to receive, as an input voltage, a voltage generated by an intermediate bus converter configured to step down a DC bus voltage; a second input terminal configured to receive the DC bus voltage; a capacitor connection terminal to which an external capacitor is to be connected; an output terminal to which a load is to be connected; a first switch connected between the first input terminal and the output terminal; a charging circuit connected between the second input terminal and the capacitor connection terminal; and an internal converter configured to step down a voltage of the capacitor connection terminal and stabilize an output voltage generated at the output terminal to a target level.

According to the above configuration, the DC bus voltage of about 40 to 50 V is supplied to the power loss protection circuit, and this DC bus voltage is used to charge a capacitor for backup, eliminating the need for charging by using a boost converter as in the related art. This makes it possible to reduce losses. In addition, in the related art, it was necessary to switch operating modes of the boost converter, but according to this configuration, since an internal converter only needs to operate in one direction in a step-down mode, switching is not necessary.

In an embodiment of the present disclosure, a target level of the internal converter may be lower than the input voltage, and the internal converter may operate constantly regardless of presence or absence of the input voltage. According to this configuration, it is not necessary to control the switching between enable and disable of the internal converter according to a state of the input voltage. Further, while the input voltage is being supplied normally, since the internal converter is in a light load state and operates in a pulse frequency modulation (PFM) mode, there is only a slight increase in switching loss due to the internal converter being constantly enabled.

In an embodiment of the present disclosure, the internal converter may be enabled when the input voltage is interrupted.

In an embodiment of the present disclosure, the charging circuit may include a second switch, and an on-resistance of the second switch may be higher than an on-resistance of the first switch. Since a charging speed may be slow, an increase in a circuit area can be suppressed by using an element with a high on-resistance, i.e., a small size.

In an embodiment of the present disclosure, the power loss protection circuit may further include: a third switch connected between an output of the internal converter and the output terminal; and a switch control circuit configured to control the third switch.

In an embodiment of the present disclosure, the switch control circuit may turn off the third switch when a voltage of the capacitor connection terminal is lower than the output voltage. This makes it possible to prevent a capacitor for backup from being charged via the internal converter.

In an embodiment of the present disclosure, the switch control circuit may limit a current flowing through the third switch. This makes it possible to prevent a capacitor for backup from being charged by an overcurrent via the internal converter.

In an embodiment of the present disclosure, the switch control circuit may control the third switch by soft start control.

In an embodiment of the present disclosure, the charging circuit may operate so that the voltage of the capacitor connection terminal does not exceed a predetermined voltage of 35 V or lower. This makes it possible to use an element with a 35 V withstand voltage as a capacitor for backup, thereby reducing costs.

In an embodiment of the present disclosure, the charging circuit may include: a second switch; and a control circuit configured to turn off the second switch when the voltage of the capacitor connection terminal exceeds the predetermined voltage.

In an embodiment of the present disclosure, the charging circuit may include a regulator configured to stabilize the voltage of the capacitor connection terminal.

In an embodiment of the present disclosure, the charging circuit may further include a clamp circuit configured to clamp the voltage of the capacitor connection terminal so as not to exceed a predetermined voltage.

A data storage module according to an embodiment of the present disclosure is attachable to or detachable from a server. This data storage module includes: a first terminal to receive a first voltage, which is an output voltage of an intermediate bus converter, from the server; a second terminal to receive a second voltage, which is an input voltage of the intermediate bus converter, from the server; a power supply circuit; and a power loss protection circuit configured to receive the first voltage and the second voltage and supply a power supply voltage to the power supply circuit. The power loss protection circuit includes: a capacitor; a first switch connected between the first terminal and an input terminal of the power supply circuit; a charging circuit connected between the second terminal and the capacitor; and an internal converter configured to step down the voltage of the capacitor and supply an output voltage stabilized at a target level to the power supply circuit.

In an embodiment of the present disclosure, the internal converter may operate regardless of presence or absence of the first voltage, and a target level of the output of the internal converter may be lower than the first voltage.

In an embodiment of the present disclosure, the internal converter is turned on when the first voltage is interrupted.

In an embodiment of the present disclosure, the charging circuit may include a second switch, and an on-resistance of the second switch may be higher than an on-resistance of the first switch.

In an embodiment of the present disclosure, the data storage module may further include: a third switch connected between the output of the internal converter and the input terminal of the power supply circuit; and a switch control circuit configured to control the third switch.

In an embodiment of the present disclosure, the switch control circuit may turn off the third switch when the voltage of the capacitor is lower than the output voltage.

In an embodiment of the present disclosure, the switch control circuit may control the third switch so that a current flowing through the third switch does not exceed an upper limit current.

In an embodiment of the present disclosure, the switch control circuit may control the third switch by soft start control.

In an embodiment of the present disclosure, the charging circuit may operate so as not to cause the voltage of the capacitor to exceed a predetermined voltage of 35 V or lower.

In an embodiment of the present disclosure, the charging circuit may include: a second switch; and a control circuit configured to turn off the second switch when the voltage of the capacitor exceeds the predetermined voltage.

In an embodiment of the present disclosure, the charging circuit may include a regulator configured to stabilize the voltage of the capacitor.

In an embodiment of the present disclosure, the charging circuit may further include a clamp circuit configured to clamp the voltage of the capacitor so as not to exceed a predetermined voltage.

A server according to an embodiment of the present disclosure is configured so that the above-described data storage module is attachable to or detachable from the server. The server includes: a third terminal configured to receive a voltage generated by an intermediate bus converter configured to step down a DC bus voltage; a fourth terminal configured to receive the DC bus voltage; a fifth terminal to be connected to the first terminal of the data storage module; a sixth terminal to be connected to the second terminal of the data storage module; a first wiring configured to connect the third terminal and the fifth terminal; and a second wiring configured to connect the fourth terminal and the sixth terminal.

### EMBODIMENTS

Preferred embodiments of the present disclosure will be described below with reference to the drawings. Like or equivalent components, members, and processes illustrated in the respective drawings are given like reference numerals and a repeated description thereof will be properly omitted. Further, the embodiments are presented by way of example only and are not intended to limit the present disclosure, and all features or any combination thereof described in the embodiments may not necessarily be essential to the present disclosure.

In the present disclosure, “a state where a member A is connected to a member B” includes not only a case where the member A and the member B are physically directly connected but also a case where the member A and the member B are indirectly connected via any other member that does not affect an electrical connection state between the members A and B or does not impair functions thereof. Further, “a state where a member C is installed between a member A and a member B” includes not only a case where the member A and the member C or the member B and the member C are directly connected but also a case where the member A and the member C or the member B and the member Care indirectly connected via any other member that does not affect an electrical connection state between the members A and C or the members B and C or does not impair functions thereof.

### First Embodiment

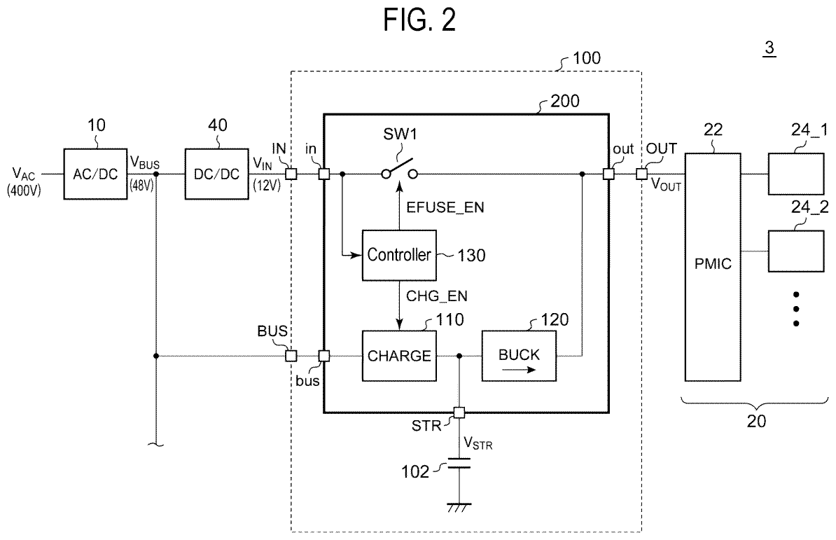

FIG. 2 is a circuit diagram of a system 3 including a backup circuit 100 according to an embodiment of the present disclosure. The system 3 includes a main power supply 10, an intermediate bus converter 40, a load 20, and a backup circuit 100.

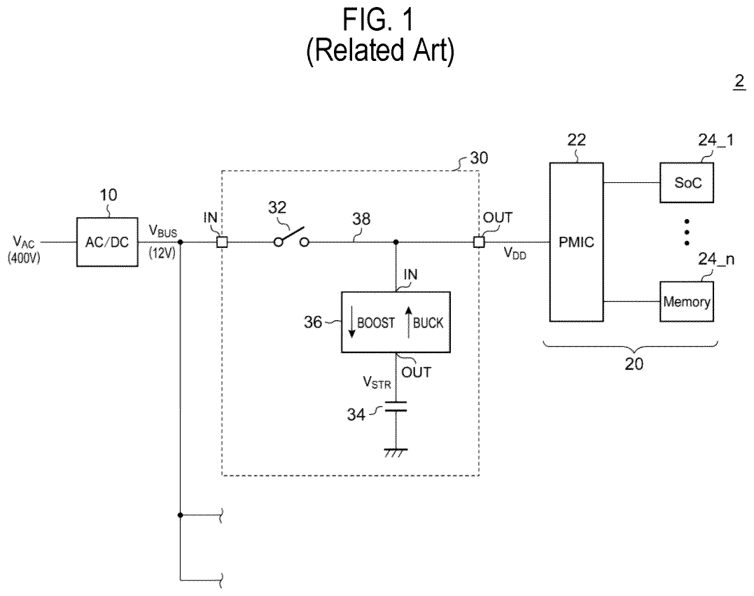

In the system 2 of FIG. 1, a DC bus voltage V_{BUS} generated by the main power supply 10 is 12 V, whereas in the system 3 of FIG. 2, a bus voltage V_{BUS} generated by the main power supply 10 is a voltage of about 40 to 50 V (specifically, 48 V, 52 V, 42 V, etc., and 48 V in the present embodiment), which is higher than 12 V.

This system 3 is provided with the intermediate bus converter 40 that does not exist in the system 2 of FIG. 1. The intermediate bus converter 40 converts the bus voltage V_{BUS} of 48 V to a DC voltage (input voltage) V_{IN} of about 12 V which is standardly adopted in many electronic circuits.

The input voltage V_{IN} generated by the intermediate bus converter 40 is supplied to a first input terminal IN of the backup circuit 100. The backup circuit 100 further includes a second input terminal BUS to which the bus voltage V_{BUS} is supplied. The load 20 is connected to an output terminal OUT of the backup circuit 100. While the input voltage V_{IN} is being supplied normally, the backup circuit 100 supplies the input voltage V_{IN} as an output voltage V_{OUT} to the load 20. Further, the backup circuit 100 also charges a backup capacitor 102 while the input voltage V_{IN} is being supplied normally. When the input voltage V_{IN} is interrupted, the backup circuit 100 supplies the power stored in the backup capacitor 102 to the load 20.

The backup circuit 100 includes a first switch SW1, a charging circuit 110, an internal converter 120, a backup capacitor 102, and a controller 130. Main parts of the first switch SW1, the charging circuit 110, the internal converter 120, and the controller 130 are integrated into an integrated circuit (IC) called a PLP circuit 200.

The first switch SW1 is connected between a first input terminal in and an output terminal out of the PLP circuit 200. The first switch SW1 is a semiconductor switch (MOS transistor) called an E-Fuse (electronic fuse). The on/off state of the first switch SW1 is controlled according to an enable signal EFUSE_EN.

The backup capacitor 102, which is installed externally, is connected to a capacitor connection terminal STR.

The charging circuit 110 is connected between a second input terminal “bus” and the capacitor connection terminal STR. The charging circuit 110 may be switched between an enabled state and a disabled state according to an enable signal CHG_EN, and in the enabled state, it charges the backup capacitor 102 by using the bus voltage V_{BUS} of 48 V.

The controller 130 determines whether the input voltage V_{IN} is normal or interrupted, and generates the enable signals EFUSE_EN and CHG_EN. The controller 130 asserts the enable signal EFUSE_EN so that the first switch SW1 is turned on while the input voltage V_{IN} is being supplied normally, and negates the enable signal EFUSE_EN so that the first switch SW1 is turned off when the input voltage V_{IN} is interrupted.

In addition, the controller 130 asserts the enable signal CHG_EN so that the charging circuit 110 is enabled while the input voltage V_{IN} is being supplied normally, and negates the enable signal CHG_EN so that the charging circuit 110 is disabled when the input voltage V_{IN} is interrupted.

The input of the internal converter 120 is connected to the capacitor connection terminal STR, and the output thereof is connected to the output terminal out. The internal converter 120 is an isolated or non-isolated step-down converter, which is configured to, when the input voltage V_{IN} is interrupted, step down the voltage V_{STR} of the capacitor connection terminal STR (i.e., the voltage of the backup capacitor 102) and generate a voltage V_{OUT} which is stabilized at a voltage level V_{OUT(REF)} higher than a minimum operating voltage of the load 20, at the output terminal out. In other words, the internal converter 120 regulates the output voltage V_{OUT} so as to approach a target level V_{OUT(REF)}.

The above is a basic configuration of the backup circuit 100. In this configuration, the DC bus voltage V_{BUS} of about 40 to 50 V is supplied to the backup circuit 100 and is used to charge the backup capacitor 102. This eliminates the need for charging by using a boost converter as in the related art, thereby reducing losses. Further, in the related art, it was necessary to configure the boost converter so as to operate bi-directionally to switch operating modes, but according to this configuration, since the internal converter 120 only needs to operate in one direction in a step-down mode, switching is not necessary.

A more preferable configuration and features of the backup circuit 100 in FIG. 2 will be described below.

The target level V_{OUT(REF)} of the internal converter 120 may be set to be lower than the voltage level (12 V) of the input voltage V_{IN}. When V_{IN} is 12 V, V_{OUT(REF)} may be set to about 9 to 11 V (for example, 10 V). Then, the internal converter 120 may be set to operate constantly regardless of presence or absence of the input voltage V_{IN}.

According to the above configuration, it is not necessary to control the switching between enable and disable of the internal converter 120 according to the state of the input voltage V_{IN}. Further, while the input voltage V_{IN} is being supplied normally, since the internal converter 120 is in a light load state and operates in a pulse frequency modulation (PFM) mode, there is only a slight increase in switching loss due to the internal converter 120 being constantly enabled.

Next, a specific example of a configuration of the backup circuit 100 will be described.

### First Example

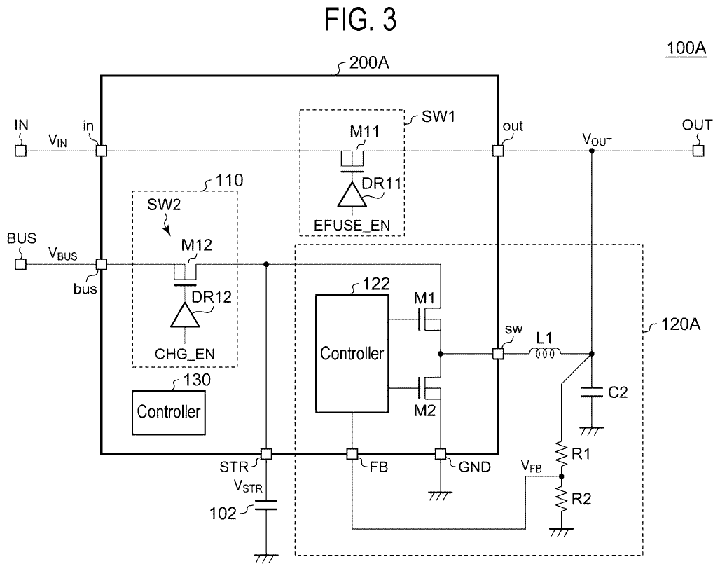

FIG. 3 is a circuit diagram of a backup circuit 100A according to a first example.

A first switch SW1 is a semiconductor switch and includes a MOS transistor M11 and a driver DR11. The MOS transistor M11 may be either an N-channel type or a P-channel type. In this example, the MOS transistor M11 is integrated into a PLP circuit 200A. The driver DR11 turns on the MOS transistor M11 in response to assertion of an enable signal EFUSE_EN.

A charging circuit 110 includes a second switch SW2 connected between a second input terminal bus and a capacitor connection terminal STR. The second switch SW2 is a semiconductor switch like the first switch SW1 and includes a MOS transistor M12 and a driver DR12. The driver DR12 turns on the MOS transistor M12 in response to assertion of an enable signal CHG_EN, enabling the charging circuit 110.

When the second switch SW2 is turned on, a charging current flows from the second input terminal bus to the capacitor connection terminal STR via the second switch SW2, charging the backup capacitor 102.

Since a large current flows through the first switch SW1, the MOS transistor M11 is required to have a low on-resistance and a large size. On the other hand, since the charging of the backup capacitor 102 may be slow, the MOS transistor M12 of the second switch SW2 may have a high on-resistance, and therefore have a small size. Therefore, the second switch SW2 can be easily miniaturized.

An internal converter 120A includes a converter controller 122, a high-side transistor (switching transistor) M1 and a low-side transistor (synchronous rectification transistor) M2, which are NMOS transistors, an inductor L1, a capacitor C2, and resistors R1 and R2. The converter controller 122, the high-side transistor M1, and the low-side transistor M2 are integrated into the PLP circuit 200A, and the inductor L1 and the capacitor C2 may be chip components. The high-side transistor M1 may be a PMOS transistor. The high-side transistor M1 and the low-side transistor M2 may be constituted by discrete components. A feedback signal V_{FB} indicating the output voltage V_{OUT} generated at an output terminal out is input to the converter controller 122. For example, the feedback signal V_{FB} is a voltage obtained by dividing the output voltage V_{OUT} by the resistors R1 and R2. The resistors R1 and R2 may be integrated into the PLP circuit 200A.

The converter controller 122 controls the switching of the high-side transistor M1 and the low-side transistor M2 so that the feedback signal V_{FB} approaches a reference voltage V_{REF}. The target level V_{OUT(REF)} of the output voltage V_{OUT} equals V_{REF}×(R1+R2)/R2 and is set to be lower than the input voltage V_{IN}.

As described above, the internal converter 120A operates constantly regardless of presence or absence of the input voltage V_{IN}. When the input voltage V_{IN} is supplied, since the voltage V_{OUT} of the output terminal out is higher than the target level V_{OUT(REF)}, the internal converter 120A operates in a light load state. In the light load state, the converter controller 122 turns on the high-side transistor M1 once (or several times), and then operates in a PFM mode in which switching is stopped for a long period of time. When the input voltage V_{IN} is interrupted, since a load current to the load 20 is supplied via the internal converter 120A, the internal converter 120A is in a heavy load state. In the heavy load state, the converter controller 122 feedback-controls duty cycles of the high-side transistor M1 and the low-side transistor M2 so that the feedback signal V_{FB} approaches the reference voltage V_{REF}.

Next, an operation of the backup circuit 100A will be described.

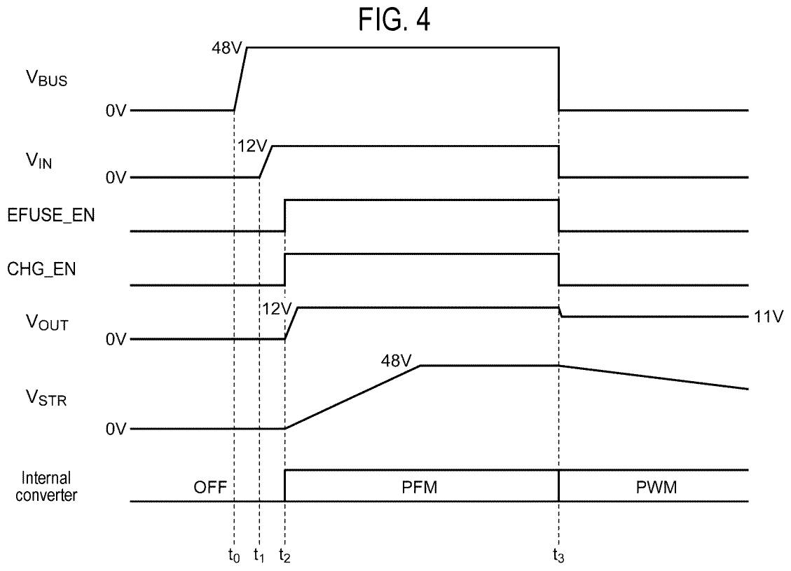

FIG. 4 is a time chart illustrating an operation of the backup circuit 100A of FIG. 3. At time to, the bus voltage V_{BUS} rises. At time t1, the intermediate bus converter 40 starts up, and the input voltage V_{IN} of 12 V is supplied to the backup circuit 100.

When the controller 130 detects the input voltage V_{IN} at time t2, the enable signals EFUSE_EN and CHG_EN are asserted, the first switch SW1 is turned on, and the charging circuit 110 is enabled. When the first switch SW1 is turned on, the output voltage V_{OUT} rises to 12 V. In addition, the charging circuit 110 starts charging the backup capacitor 102, and the voltage V_{STR} of the backup capacitor 102 rises toward 48 V. The internal converter 120 operates in a PFM mode.

At time t3, the input voltage V_{IN} is interrupted. When the controller 130 detects the interruption, the enable signals EFUSE_EN and CHG_EN are negated, the first switch SW1 is turned off, and the charging circuit 110 is disabled. The internal converter 120 transitions to the PWM mode, and the output voltage V_{OUT} is stabilized at the target level V_{OUT(REF)} of 12 V. Thereafter, the voltage V_{STR} of the backup capacitor 102 decreases.

The above is the operation of the backup circuit 100.

As shown in FIG. 4, in the PLP circuit 200A of FIG. 3, the first switch SW1 and the second switch SW2 are turned on at startup (immediately after time t1 in FIG. 4). Since the on-resistance of the first switch SW1 is low, when the first switch SW1 is turned on, the output voltage V_{OUT} quickly rises to a voltage level equal to the input voltage V_{IN}. On the other hand, since the on-resistance of the second switch SW2 is high, the backup capacitor 102 is charged slowly.

Depending on a combination of the on-resistance of the first switch SW1 and the on-resistance of the second switch SW2, a situation where V_{STR}<V_{OUT} may occur immediately after the startup of the PLP circuit 200A. When V_{STR}<V_{OUT} occurs, a reverse current flows from the output terminal out to the capacitor connection terminal STR via the inductor L1 and a body diode of the high-side transistor M1. In a case where an impedance of a reverse charging path via the internal converter 120 is low, an inrush current may occur. Configurations described in second to fourth examples can be a solution to this issue.

### Second Example

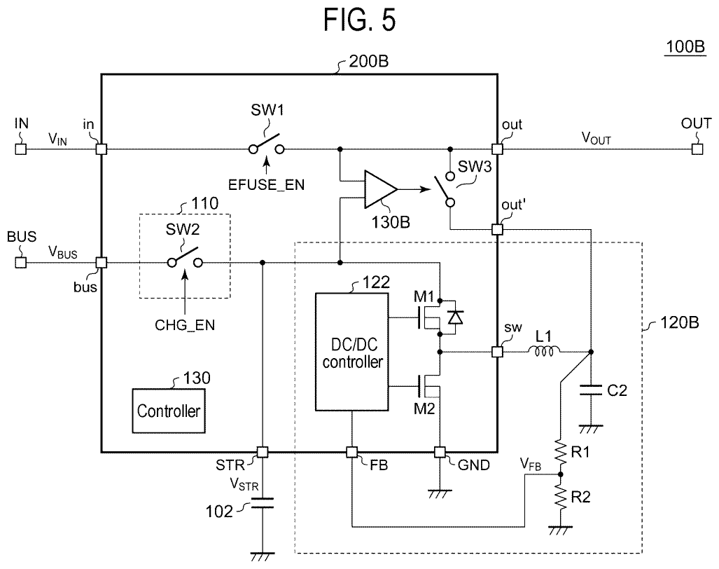

FIG. 5 is a circuit diagram of a backup circuit 100B according to a second example. A PLP circuit 200B includes a third switch SW3 and a switch control circuit 130B. A terminal out′ of the PLP circuit 200B is connected to an output node of an internal converter 120B. The third switch SW3 is connected between the terminals out′ and out. The switch control circuit 130B turns off the third switch SW3 when V_{OUT}>V_{STR}, and turns on the third switch SW3 when V_{OUT}<V_{STR}. This makes it possible to prevent a reverse current from flowing through the internal converter 120B, thereby preventing an inrush current from occurring. Although the third switch SW3 is constituted by an NMOS transistor herein, the third switch SW3 may be configured with a PMOS transistor.

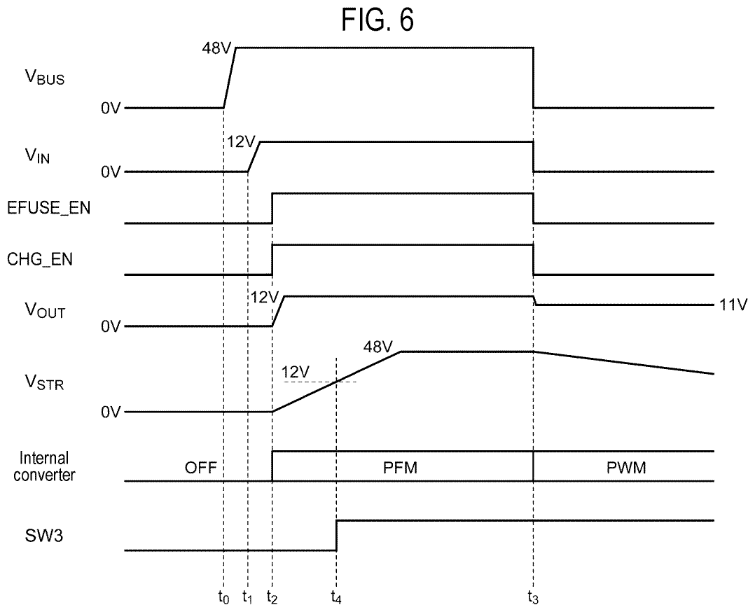

FIG. 6 is a time chart illustrating an operation of the backup circuit 100B of FIG. 5.

A basic operation is the same as that of the backup circuit 100A. At time t2, the third switch SW3 is turned off, and no reverse current flows from the output terminal out to the backup capacitor 102. When the voltage V_{STR} of the backup capacitor 102 exceeds the input voltage V_{IN} at time t4, the third switch SW3 is turned on.

### Third Example

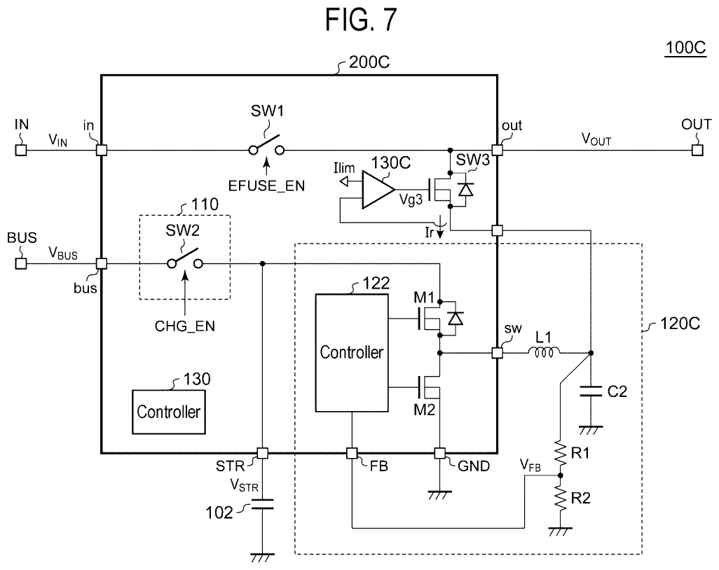

FIG. 7 is a circuit diagram of a backup circuit 100C according to a third example. A switch control circuit 130C limits a reverse current Ir flowing through a third switch SW3 so as not to exceed an upper limit current Ilim during a period when the reverse current Ir may occur immediately after startup of the backup circuit 100C (current limiting function). The third transistor SW3 is a MOS transistor, and the switch control circuit 130C detects a drain current Ir of the MOS transistor and regulates a gate voltage Vg3 of the MOS transistor so that a detection signal does not exceed a threshold value. When the voltage V_{STR} of the backup capacitor 102 becomes higher than the input voltage V_{IN} and there is no risk of reverse current, the switch control circuit 130C fully turns on the MOS transistor.

According to the third example, by allowing the reverse current Ir, the backup capacitor 102 may be charged through a path separate from the second switch SW2, thereby shortening a charging time. In addition, by limiting an amount of the reverse current Ir, an inrush current can be prevented.

### Fourth Example

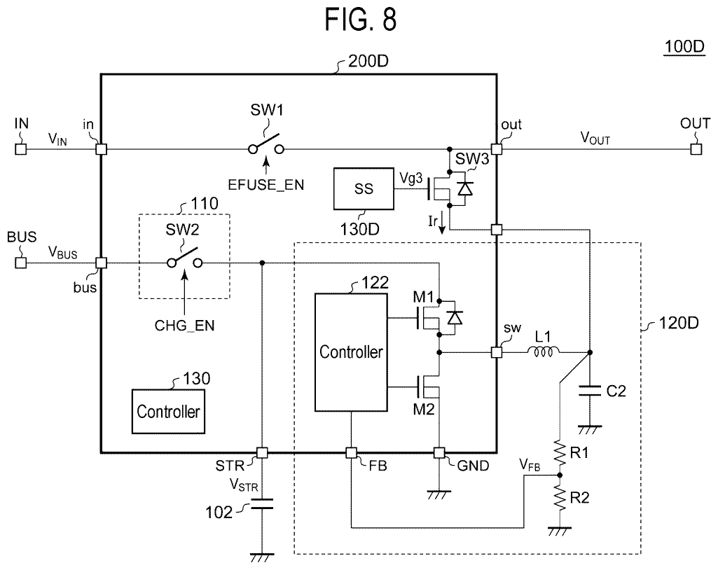

FIG. 8 is a circuit diagram of a backup circuit 100D according to a fourth example. When the backup circuit 100D is started up, a switch control circuit 130D gently increases a gate-source voltage of a MOS transistor serving as a third switch SW3 over time, and gradually reduces an on-resistance of the third switch SW3 (soft start control).

As a result, during a period in which the reverse current Ir may occur, since the on-resistance of the third switch SW3 is high, it is possible to suppress the reverse current Ir from increasing, thereby suppressing an inrush current.

According to the fourth example, by allowing the reverse current Ir, a backup capacitor 102 can be charged through a path separate from a second switch SW2, thereby shortening a charging time. In addition, by limiting an amount of the reverse current Ir, the inrush current can be prevented.

### Fifth Example

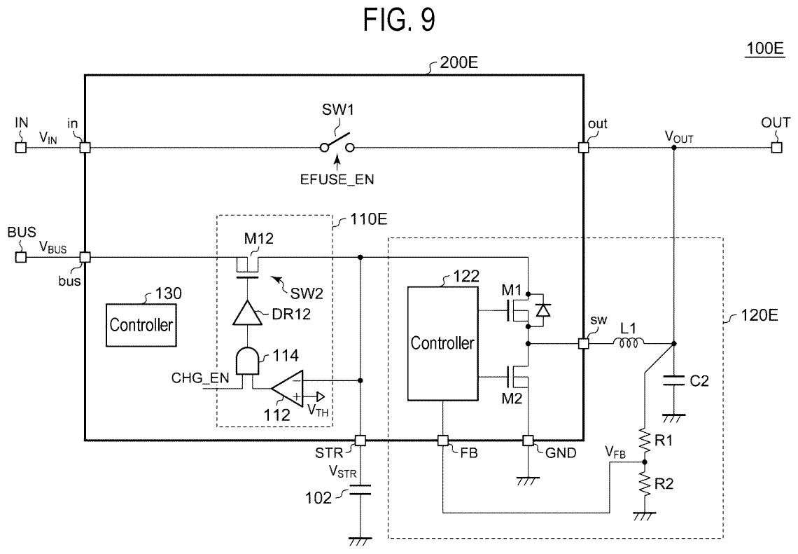

FIG. 9 is a circuit diagram of a backup circuit 100E according to a fifth example. A charging circuit 110E operates so that the voltage V_{STR} of the backup capacitor 102 does not become higher than a predetermined upper limit voltage V_{TH}.

The charging circuit 110E includes a comparator 112 and a logic gate 114 in addition to a MOS transistor M12 and a driver DR12. The comparator 112 compares the voltage V_{STR} of the backup capacitor 102 with an upper limit voltage V_{TH}. The logic gate 114 performs a logical operation on an enable signal CHG_EN and an output of the comparator 112. The driver DR12 controls the MOS transistor M12 based on an output of the logic gate 114.

For example, the comparator 112 outputs high when V_{STR}<V_{TH} and low when V_{STR}>V_{TH}. The logic gate 114 is an AND gate and generates a logical product of the output of the comparator 112 and the enable signal CHG_EN. The driver DR12 turns on the MOS transistor M12 when the output of the logic gate 114 is high.

The upper limit voltage V_{TH} is preferably set to 35 V or lower. This allows an element with a withstand voltage of 35 V to be used for the backup capacitor 102, reducing costs as compared with a component with a withstand voltage of 48 V.

### Sixth Example

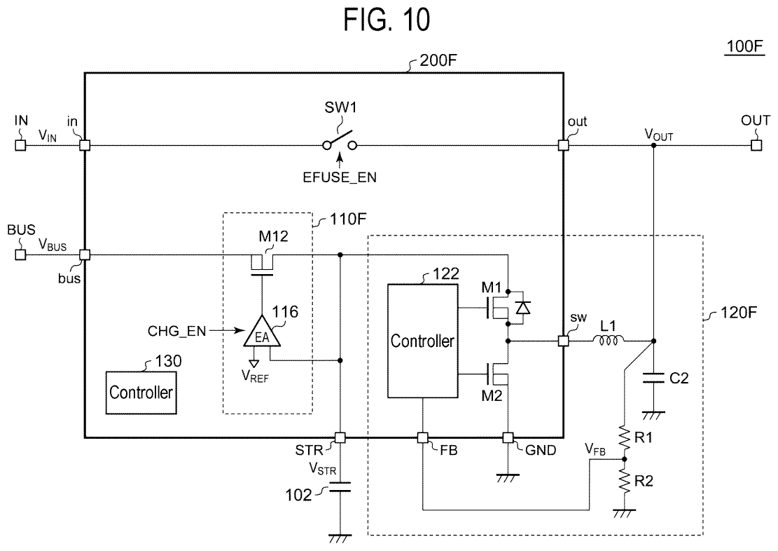

FIG. 10 is a circuit diagram of a backup circuit 100F according to a sixth example. A charging circuit 110F includes a linear regulator configured to stabilize the voltage V_{STR} of the backup capacitor 102 to a predetermined target level V_{STR(REF)}. The charging circuit 110F includes a MOS transistor M12 and an error amplifier 116. The error amplifier 116 is turned on when an enable signal CHG_EN is asserted, amplifies an error between the voltage V_{STR} of the backup capacitor 102 and the target level V_{STR(REF)}, and controls a gate voltage of the MOS transistor M12. By setting the target level V_{STR(REF)} to 35 V or lower, an element with a withstand voltage of 35 V may be used for the backup capacitor 102, reducing costs as compared to a component with a withstand voltage of 48 V.

The third switch SW3 described in the second example to the fourth example may be added to the backup circuit 100E or the backup circuit 100F according to the fifth example or the sixth example.

### Seventh Example

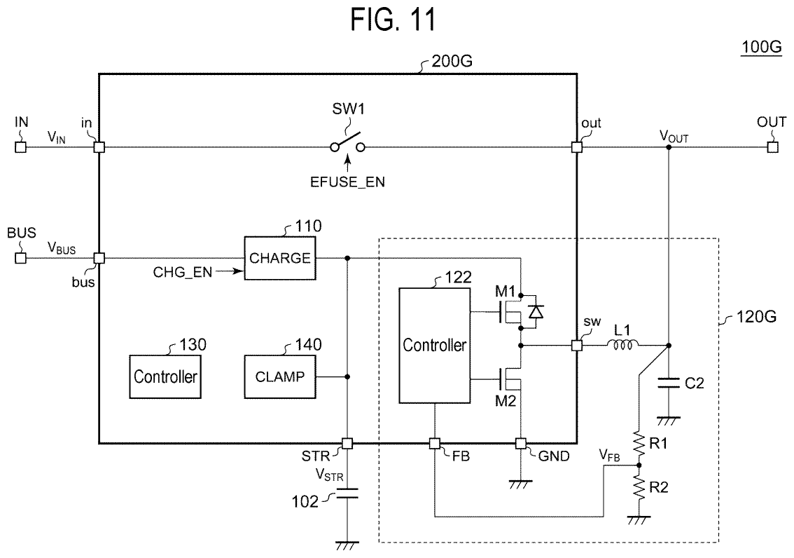

FIG. 11 is a circuit diagram of a backup circuit 100G according to a seventh example. The charging circuit 110 may be the one described in the fifth example or the sixth example, or the one described in the first example.

The PLP circuit 200G includes a clamp circuit 140. The clamp circuit 140 clamps the voltage V_{STR} of the backup capacitor 102 so as not to exceed an upper limit voltage V_{LIM}. By setting the upper limit voltage V_{LIM} to 35 V or lower, an element with a withstand voltage of 35 V can be used for the backup capacitor 102, reducing costs as compared to a component with a withstand voltage of 48 V. The upper limit voltage V_{LIM} may be equal to or different from the above-mentioned upper limit voltage V_{TH}.

The third switch SW3 described in the second to fourth examples may be added to the backup circuit 100G according to the seventh example.

In other words, various components described in the first to seventh examples may be combined in any way.

Next, modifications of the backup circuit 100 will be described.

### (First Modification)

When the input voltage V_{IN} is interrupted, the internal converter 120 may be enabled, and when the input voltage V_{IN} is supplied, the internal converter 120 may be disabled. In this case, a circuit (for example, a voltage comparator) configured to monitor the input voltage V_{IN} may be added.

### (Second Modification)

For the first switch SW1, the second switch SW2, and the third switch SW3, the MOS transistors M11, M12, and M13 may be discrete components. In such a case, the MOS transistors M11 to M13 are externally attached to the PLP circuit 200.

Next, an example of an actual application of the system 2 will be described.

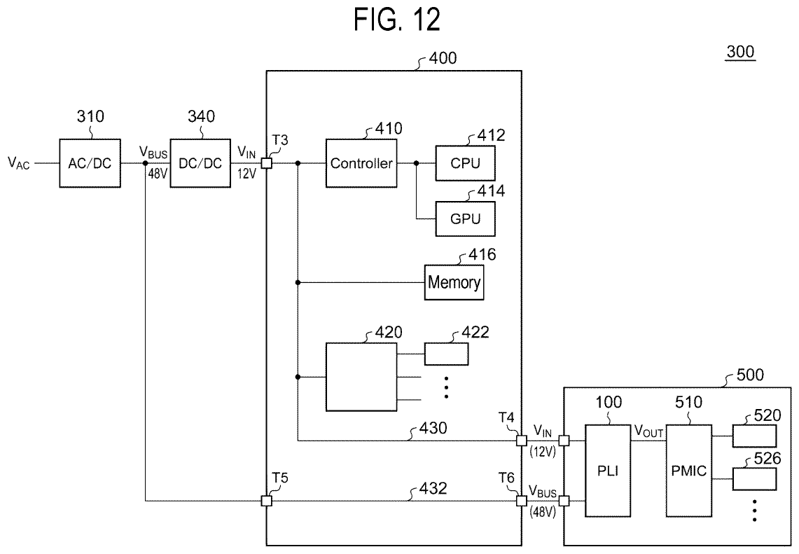

FIG. 12 is a circuit diagram of a computer system 300. The computer system 300 includes a main power supply 310, an intermediate bus converter 340, a server (main body) 400, and a data storage module 500. The computer system 300 is installed, for example, in a data center.

The main power supply 310 corresponds to the main power supply 10 of FIG. 2 and generates a bus voltage V_{BUS} of about 40 to 50 V. The intermediate bus converter 340 corresponds to the intermediate bus converter 40 of FIG. 2 and generates a voltage V_{IN} of 12 V.

An input voltage V_{IN} is supplied to a terminal T3 of a server 400. The server 400 includes a controller 410, a CPU 412, a GPU 414, a memory 416, a power supply 420, and other electronic components 422. The controller 410 performs an overall control of the entire server 400. In addition, the controller 410 supplies a power supply voltage to the CPU 412 and the GPU 414. The power supply 420 supplies a power supply voltage to the electronic components 422. The electronic components 422 may include various controllers, interface circuits, and peripheral circuits.

The data storage module 500 is attachable to or detachable from the server 400 and is, for example, a solid state disk (SSD) module. The data storage module 500 may be a hard disk.

The data storage module 500 includes a backup circuit 100, a power management circuit or power management IC (PMIC) 510, and a plurality of electronic components 520. The plurality of electronic components 520 may be, for example, a controller, a NAND flash, a cache memory, an interface, etc. The PMIC 510 supplies power supply voltages of appropriate voltage levels to the plurality of electronic components 520 in an appropriate sequence.

The backup circuit 100 is required to be supplied with a bus voltage V_{BUS} of 48 V in addition to an input voltage V_{IN} of 12 V. The server 400 includes a terminal T5 configured to receive the bus voltage V_{BUS}. The server 400 also includes a terminal T4 to be connected to a terminal IN of the backup circuit 100, and a terminal T6 to be connected to a terminal BUS of the backup circuit 100. It is to be noted that the bus voltage V_{BUS} of 48 V is not used for the server 400 and is drawn in so as to be supplied to the PLP circuit 200.

The backup circuit 100 is provided with a first wiring 430 and a second wiring 432 so as to supply voltages of 12 V and 48 V to the data storage module 500. The first wiring 430 connects between the terminals T3 and T5 of the server 400 and serves as a supply path for the input voltage V_{IN}. The second wiring 432 connects between the terminals T4 and T6 of the server 400 and serves as a supply path for the bus voltage V_{BUS}.

The present disclosure has been described by using specific terms based on the embodiments, but the embodiments merely show principles and applications of the present disclosure, and many modifications and changes in arrangement are permitted in the embodiments without departing from the spirit of the present disclosure defined in the claims.

### (Supplementary Notes)

The following techniques are disclosed in the present disclosure.

### (Supplementary Note 1)

A power loss protection circuit including:
a first input terminal configured to receive, as an input voltage, a voltage generated by an intermediate bus converter configured to step down a DC bus voltage;
a second input terminal configured to receive the DC bus voltage;
a capacitor connection terminal to which an external capacitor is to be connected;
an output terminal to which a load is to be connected;
a first switch connected between the first input terminal and the output terminal;
a charging circuit connected between the second input terminal and the capacitor connection terminal; and
an internal converter configured to step down a voltage of the capacitor connection terminal and stabilize an output voltage generated at the output terminal to a target level.

### (Supplementary Note 2)

The power loss protection circuit of Supplementary Note 1, wherein the target level of
the internal converter is lower than the input voltage, and the internal converter operates regardless of presence or absence of the input voltage.

### (Supplementary Note 3)

The power loss protection circuit of Supplementary Note 1, wherein the internal converter is enabled when the input voltage is interrupted.

### (Supplementary Note 4)

The power loss protection circuit of any one of Supplementary Notes 1 to 3, wherein the charging circuit includes a second switch, and an on-resistance of the second switch is higher than an on-resistance of the first switch.

### (Supplementary Note 5)

The power loss protection circuit of any one of Supplementary Notes 1 to 4, further including:
a third switch connected between an output of the internal converter and the output terminal; and
a switch control circuit configured to control the third switch.

### (Supplementary Note 6)

The power loss protection circuit of Supplementary Note 5, wherein the switch control circuit turns off the third switch when the voltage of the capacitor connection terminal is lower than the output voltage.

### (Supplementary Note 7)

The power loss protection circuit of Supplementary Note 5, wherein the switch control circuit controls the third switch so that a current flowing through the third switch does not exceed an upper limit current.

### (Supplementary Note 8)

The power loss protection circuit of Supplementary Note 5, wherein the switch control circuit controls the third switch by soft start control.

### (Supplementary Note 9)

The power loss protection circuit of any one of Supplementary Notes 1 to 8, wherein the charging circuit operates so that the voltage of the capacitor connection terminal does not exceed a predetermined voltage of 35 V or lower.

### (Supplementary Note 10)

The power loss protection circuit of Supplementary Note 9, wherein the charging circuit includes:
a second switch; and
a control circuit configured to turn off the second switch when the voltage of the capacitor connection terminal exceeds the predetermined voltage.

### (Supplementary Note 11)

The power loss protection circuit of Supplementary Note 9, wherein the charging circuit includes a regulator configured to stabilize the voltage of the capacitor connection terminal.

### (Supplementary Note 12)

The power loss protection circuit of any one of Supplementary Notes 1 to 11, wherein the charging circuit further includes a clamp circuit configured to clamp the voltage of the capacitor connection terminal so as not to exceed a predetermined voltage.

### (Supplementary Note 13)

A data storage module that is a solid state disk (SSD) module which is attachable to or detachable from a server, including:
a first terminal configured to receive a first voltage, which is an output voltage of an intermediate bus converter, from the server;
a second terminal configured to receive a second voltage, which is an input voltage of the intermediate bus converter, from the server;
a power supply circuit; and
a power loss protection circuit configured to receive the first voltage and the second voltage and supply a power supply voltage to the power supply circuit, wherein the power loss protection circuit includes:
a capacitor;
a first switch connected between the first terminal and an input terminal of the power supply circuit;
a charging circuit connected between the second terminal and the capacitor; and
an internal converter configured to step down a voltage of the capacitor and supply an output voltage stabilized at a target level to the power supply circuit.

### (Supplementary Note 14)

The data storage module of Supplementary Note 13, wherein the internal converter is turned on regardless of presence or absence of the first voltage, and the target level of the internal converter is lower than the first voltage.

### (Supplementary Note 15)

The data storage module of Supplementary Note 13, wherein the internal converter is turned on when the first voltage is interrupted.

### (Supplementary Note 16)

The data storage module of any one of Supplementary Notes 13 to 15, wherein the charging circuit includes a second switch, and an on-resistance of the second switch is higher than an on-resistance of the first switch.

### (Supplementary Note 17)

The data storage module of Supplementary Note 14, further including:
a third switch connected between the output of the internal converter and the input terminal of the power supply circuit; and
a switch control circuit configured to control the third switch.

### (Supplementary Note 18)

The data storage module of Supplementary Note 17, wherein the switch control circuit turns off the third switch when the voltage of the capacitor is lower than the output voltage.

### (Supplementary Note 19)

The data storage module of Supplementary Note 17, wherein the switch control circuit controls the third switch so that a current flowing through the third switch does not exceed an upper limit current.

### (Supplementary Note 20)

The data storage module of Supplementary Note 17, wherein the switch control circuit controls the third switch by soft start control.

### (Supplementary Note 21)

The data storage module of any one of Supplementary Notes 13 to 20, wherein the charging circuit operates so that the voltage of the capacitor does not exceed a predetermined voltage of 35 V or lower.

### (Supplementary Note 22)

The data storage module of Supplementary Note 21, wherein the charging circuit includes:
a second switch; and
a control circuit configured to turn off the second switch when the voltage of the capacitor exceeds the predetermined voltage.

### (Supplementary Note 23)

The data storage module of Supplementary Note 21, wherein the charging circuit includes a regulator configured to stabilize the voltage of the capacitor.

### (Supplementary Note 24)

The data storage module of any one of Supplementary Notes 13 to 23, wherein the charging circuit further includes a clamp circuit configured to clamp the voltage of the capacitor so as not to exceed a predetermined voltage.

### (Supplementary Note 25)

A server configured so that the data storage module of any one of Supplementary Notes 12 to 24 is attachable to or detachable from the server, including:
a third terminal configured to receive a voltage generated by an intermediate bus converter configured to step down a DC bus voltage;
a fourth terminal configured to receive the DC bus voltage;
a fifth terminal configured to be connected to the first terminal of the data storage module;
a sixth terminal configured to be connected to the second terminal of the data storage module;
a first wiring configured to connect the third terminal and the fifth terminal; and
a second wiring configured to connect the fourth terminal and the sixth terminal.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A power loss protection circuit comprising:
a first input terminal configured to receive, as an input voltage, a voltage generated by an intermediate bus converter configured to step down a DC bus voltage;
a second input terminal configured to receive the DC bus voltage;
a capacitor connection terminal to which an external capacitor is to be connected;
an output terminal to which a load is to be connected;
a first switch connected between the first input terminal and the output terminal;
a charging circuit connected between the second input terminal and the capacitor connection terminal; and
an internal converter configured to step down a voltage of the capacitor connection terminal and stabilize an output voltage generated at the output terminal to a target level.

2. The power loss protection circuit of claim 1, wherein the target level of the internal converter is lower than the input voltage, and the internal converter operates regardless of presence or absence of the input voltage.

3. The power loss protection circuit of claim 1, wherein the internal converter is enabled when the input voltage is interrupted.

4. The power loss protection circuit of claim 1, wherein the charging circuit includes a second switch, and an on-resistance of the second switch is higher than an on-resistance of the first switch.

5. The power loss protection circuit of claim 1, further comprising:
a third switch connected between an output of the internal converter and the output terminal; and
a switch control circuit configured to control the third switch.

6. The power loss protection circuit of claim 5, wherein the switch control circuit turns off the third switch when the voltage of the capacitor connection terminal is lower than the output voltage.

7. The power loss protection circuit of claim 5, wherein the switch control circuit controls the third switch so that a current flowing through the third switch does not exceed an upper limit current.

8. The power loss protection circuit of claim 5, wherein the switch control circuit controls the third switch by soft start control.

9. The power loss protection circuit of claim 1, wherein the charging circuit operates so that the voltage of the capacitor connection terminal does not exceed a predetermined voltage of 35 V or lower.

10. The power loss protection circuit of claim 9, wherein the charging circuit includes:
a second switch; and
a control circuit configured to turn off the second switch when the voltage of the capacitor connection terminal exceeds the predetermined voltage.

11. The power loss protection circuit of claim 9, wherein the charging circuit includes a regulator configured to stabilize the voltage of the capacitor connection terminal.

12. The power loss protection circuit of claim 1, wherein the charging circuit further includes a clamp circuit configured to clamp the voltage of the capacitor connection terminal so as not to exceed a predetermined voltage.

13. A data storage module that is a solid state disk (SSD) module which is attachable to or detachable from a server, comprising:
a first terminal configured to receive a first voltage, which is an output voltage of an intermediate bus converter, from the server;
a second terminal configured to receive a second voltage, which is an input voltage of the intermediate bus converter, from the server;
a power supply circuit; and
a power loss protection circuit configured to receive the first voltage and the second voltage and supply a power supply voltage to the power supply circuit, wherein the power loss protection circuit includes:
a capacitor;
a first switch connected between the first terminal and an input terminal of the power supply circuit;
a charging circuit connected between the second terminal and the capacitor; and
an internal converter configured to step down a voltage of the capacitor and supply an output voltage stabilized at a target level to the power supply circuit.

14. The data storage module of claim 13, wherein the internal converter is turned on regardless of presence or absence of the first voltage, and the target level of the internal converter is lower than the first voltage.

15. The data storage module of claim 13, wherein the internal converter is turned on when the first voltage is interrupted.

16. The data storage module of claim 13, wherein the charging circuit includes a second switch, and an on-resistance of the second switch is higher than an on-resistance of the first switch.

17. The data storage module of claim 14, further comprising:
a third switch connected between an output of the internal converter and the input terminal of the power supply circuit; and
a switch control circuit configured to control the third switch.

18. The data storage module of claim 17, wherein the switch control circuit turns off the third switch when the voltage of the capacitor is lower than the output voltage.

19. The data storage module of claim 17, wherein the switch control circuit controls the third switch so that a current flowing through the third switch does not exceed an upper limit current.

20. The data storage module of claim 17, wherein the switch control circuit controls the third switch by soft start control.
